(19) United States
(12) Patent Application Publication
(10) Pub. No.: US 2008/0057958 A1
(43) Pub. Date: Mar. 6, 2008

(54) Wireless terminal filtering options based on wireless access point attachment characteristics

(75) Inventor: James D. Bennett, San Clemente, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/646,690

(22) Filed: Dec. 27, 2006

Related U.S. Application Data
(60) Provisional application No. 60/842,232, filed on Sep. 5, 2006.

(51) Int. Cl. H04Q 7/20

(52) U.S. Cl. 455/435.1

(57) ABSTRACT

Wireless terminal filtering attachment decisions based upon type(s) of available network(s). A novel approach is presented by which one or more filter parameters is applied when making decisions of which WAP (Wireless Access Point) (e.g., including wireless local area network access points, WiMAX access points, or cellular access points) is appropriate or valid with which to associate and through which to connect to a communication network (i.e., the Internet). Certain filter parameter sets can be implemented, and changed over time (e.g., via user selection or adaptively), so that different filter parameters apply in different situations. Generally, a plurality of detected WAPs can be partitioned into available WAPs and non-available WAPs. This division can be along (1) private vs. (2) non-private, (1) private (authorization is granted) and non-private vs. (2) private (no authorization is granted), or a variety of other lines.

### CROSS REFERENCE TO RELATED PATENTS/PATENT APPLICATIONS

### Provisional Priority Claim

The present U.S. Utility patent application claims priority pursuant to 35 U.S.C. §119(e) to the following U.S. Provisional Patent Application which is hereby incorporated herein by reference in its entirety and made part of the present U.S. Utility patent application for all purposes:

1. U.S. Provisional Application Ser. No. 60/842,232, entitled “Wireless terminal filtering attachment decisions based upon type(s) of available network(s),” (Attorney Docket No. BP5453), filed Sep. 5, 2006, pending.

### BACKGROUND OF THE INVENTION

1. Technical Field of the Invention

The invention relates generally to wireless communication networks; and, more particularly, it relates to a wireless terminal's association with a selected one of a plurality of wireless access points within such communication networks.

2. Description of Related Art

Communication systems are known to support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11, IEEE 802.16, Bluetooth®, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device (or sometimes referred to as a wireless terminal), such as a cellular telephone, two-way radio, personal digital assistant (PDA), personal computer (PC), laptop computer, home entertainment equipment, etc. communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). As is known, the receiver is coupled to the antenna and includes a low noise amplifier, one or more intermediate frequency stages, a filtering stage, and a data recovery stage. The low noise amplifier receives inbound RF signals via the antenna and amplifies then. The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

As is also known, the transmitter includes a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

In many systems, the transmitter will include one antenna for transmitting the RF signals, which are received by a single antenna, or multiple antennas, of a receiver. When the receiver includes two or more antennas, the receiver will select one of them to receive the incoming RF signals. In this instance, the wireless communication between the transmitter and receiver is a single-output-single-input (SISO) communication, even if the receiver includes multiple antennas that are used as diversity antennas (i.e., selecting one of them to receive the incoming RF signals). For SISO wireless communications, a transceiver includes one transmitter and one receiver. Currently, most wireless local area networks (WLAN) that are IEEE 802.11, 802.11a, 802,11b, or 802.11g employ SISO wireless communications.

Other types of wireless communications include single-input-multiple-output (SIMO), multiple-input-single-output (MISO), and multiple-input-multiple-output (MIMO). In a SIMO wireless communication, a single transmitter processes data into radio frequency signals that are transmitted to a receiver. The receiver includes two or more antennas and two or more receiver paths. Each of the antennas receives the RF signals and provides them to a corresponding receiver path (e.g., LNA, down conversion module, filters, and ADCs). Each of the receiver paths processes the received RF signals to produce digital signals, which are combined and then processed to recapture the transmitted data.

For a multiple-input-single-output (MISO) wireless communication, the transmitter includes two or more transmission paths (e.g., digital to analog converter, filters, up-conversion module, and a power amplifier) that each converts a corresponding portion of baseband signals into RF signals, which are transmitted via corresponding antennas to a receiver. The receiver includes a single receiver path that receives the multiple RF signals from the transmitter. In this instance, the receiver uses beam forming to combine the multiple RF signals into one signal for processing.

For a multiple-input-multiple-output (MIMO) wireless communication, the transmitter and receiver each include multiple paths. In such a communication, the transmitter parallel processes data using a spatial and time encoding function to produce two or more streams of data. The transmitter includes multiple transmission paths to convert each stream of data into multiple RF signals. The receiver receives the multiple RF signals via multiple receiver paths that recapture the streams of data utilizing a spatial and time decoding function. The recaptured streams of data are combined and subsequently processed to recover the original data.

Generally speaking, a communication device can be implemented to connect to a communication network via any one of a number of possible WAPs (Wireless Access Points). One of the possible deleterious effects that may arise within such communication systems includes the situation when a communication device is trying to connect to a WAP when there are a number of possible WAPs detected. In some conventional approaches, a communication device merely attempts to connect automatically to a first available WAP with hopes of receiving access to a pathway to a packet switched backbone, i.e., Internet. Mere connection, however, does not guarantee that the pathway is available or, if so, will be provided with or without payment, passwords, etc. Even when the pathway is unavailable, the communication device retains the connection and manual user interaction with the client device is required to attempt to find a pathway via a different WAP. Connection of the different WAP may also yield no pathway. The user repeats this process until a connection with a selected WAP yields a pathway to the Internet. However, when the connection to the selected WAP fails, the communication device forces a repeat of the entire cycle by connecting and remaining connected with a different WAP, whether or not the pathway to the Internet is available. This can be a very time consuming, complex and inefficient process. Because it is very typical to find that many WAPs permit connection but refuse to provide the pathway without proper authorization (passwords and such), this inefficient process is commonplace. Undesirably, many current communication devices nevertheless detect, display, and even try to connect to these operational but effectively unavailable WAPs.

Further limitations and disadvantages of conventional and traditional approaches will become apparent to one of ordinary skill in the art through comparison of such systems with the present invention.

### BRIEF SUMMARY OF THE INVENTION

The present invention is directed to apparatus and methods of operation that are further described in the following Brief Description of the Several Views of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWINGS

FIG. 1 is a diagram showing an embodiment of a wireless communication system.

FIG. 2 is a diagram showing an embodiment of a wireless communication device.

FIG. 3 is a diagram showing an embodiment of categorization of a plurality of WAPs according to a variety of filter parameters.

FIG. 4 is a diagram showing an embodiment of sequential categorization of a plurality of WAPs according to a variety of filter parameters.

FIG. 5 is a diagram showing an embodiment of communication system including a wireless terminal and one or more WAPs.

FIG. 6 is a diagram showing an embodiment of a communication system that includes a wireless terminal and a plurality of WAPs that are operable to support bi-directional communication there between that can be employed for determining operational and performance measures that can be used for categorizing the WAPs using one or more filter parameters.

FIG. 7 is a diagram showing an embodiment of interfacing between a user and a wireless terminal.

FIG. 8 is a diagram showing an embodiment of a plurality of WAPs that undergoes categorization according to number of different filter parameter sets.

FIG. 9, FIG. 10, FIG. 11, and FIG. 12 are diagrams showing embodiments of methods for selectively connecting a wireless terminal to a communication network (e.g., to the Internet) via a WAP.

### DETAILED DESCRIPTION OF THE INVENTION

A novel approach is presented herein by which a wireless terminal selectively connects to a communication network (e.g., the Internet) via a selected WAP (Wireless Access Point). In some instances, a large number of WAPs are within a particular vicinity, and the wireless terminal includes the capability to select an appropriate WAP through which to connect to the communication network. In some embodiments, the communication network of interest is the Internet itself. The communication network can be a packet switched communication network.

Any WAP that a communication device, such as a wireless terminal, may detect within a given vicinity may be categorized into one of a number of categories, at least including: (1) those WAPs through which the wireless terminal can connect to the communication network automatically, (2) those WAPs through which the wireless terminal can connect to the communication network after meeting some requirement (e.g., providing a password, paying for the service, etc.), and (3) those WAPs that do not provide any connectivity to the communication network (e.g., there is no path to the communication network via such a WAP or that WAP is a private WAP to which the wireless terminal has no access rights). One or more filter parameters are employed to categorize each WAP and to select one of the WAPs (provided such a WAP passes the filter parameters) through which to connect to the communication network. These filter parameters can be employed to categorize the WAPs along a variety of lines including: (1) private WAPs vs. (2) non-private WAPs, (1) private WAPs (for which authorization is granted) and non-private WAPs vs. (2) private WAPs (no authorization is granted), WAPs using various types of encryption, WAPs operating according to various types of communications including various types of communication standards. In addition, the filter parameters can be employed to categorize the WAPs along other liens as well.

In one such embodiment, the communication network of interest is the Internet itself. It is also noted that when the connectivity to the communication network of interest becomes unacceptable, or if that connectivity is dropped for some reason, another WAP (which meets the conditions of the one or more filter parameters) can also be selected through which a pathway to the communication network can be achieved.

It is also noted here that there is a distinction between merely the association with a WAP and the use of a WAP as a communication network gateway (e.g., an Internet gateway). There may be situations where a wireless terminal can associate with a WAP, yet no pathway to the communication network is available or can be achieved via that WAP. In some embodiments, a wireless terminal can associate with many WAPs, yet only one or a subset of those WAPs with which the wireless terminal can associate pass the one or more filter parameters as being desirable or appropriate through which to connect to the communication network (e.g., the Internet in one embodiment). When dealing with certain WAPs, those WAPs provide no information back to a wireless terminal regarding the communication network pathway availability provided by that WAP. When dealing with other types of WAPs, those WAPs do in fact provide information back to a wireless terminal regarding the communication network pathway availability provided by that WAP. For example, the WAP could communicate its communication network pathway capability to the wireless terminal during association between the wireless terminal and the WAP.

Generally speaking, it should be noted that association between a wireless terminal and a WAP does not necessarily mean that the wireless terminal has a gateway to the communication network via that particular WAP. The indication of whether a particular WAP can provide a pathway to the communication network for the wireless terminal can be viewed as being a communication network pathway characteristic. In the case in which the communication network is the Internet, the communication network pathway characteristic is an Internet pathway characteristic.

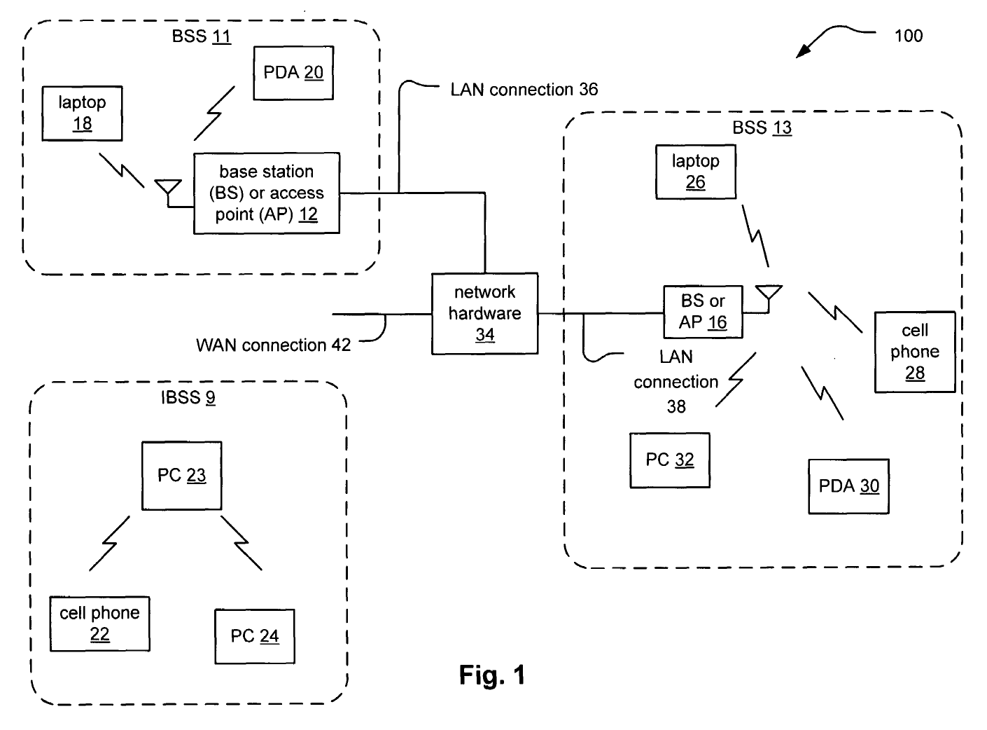

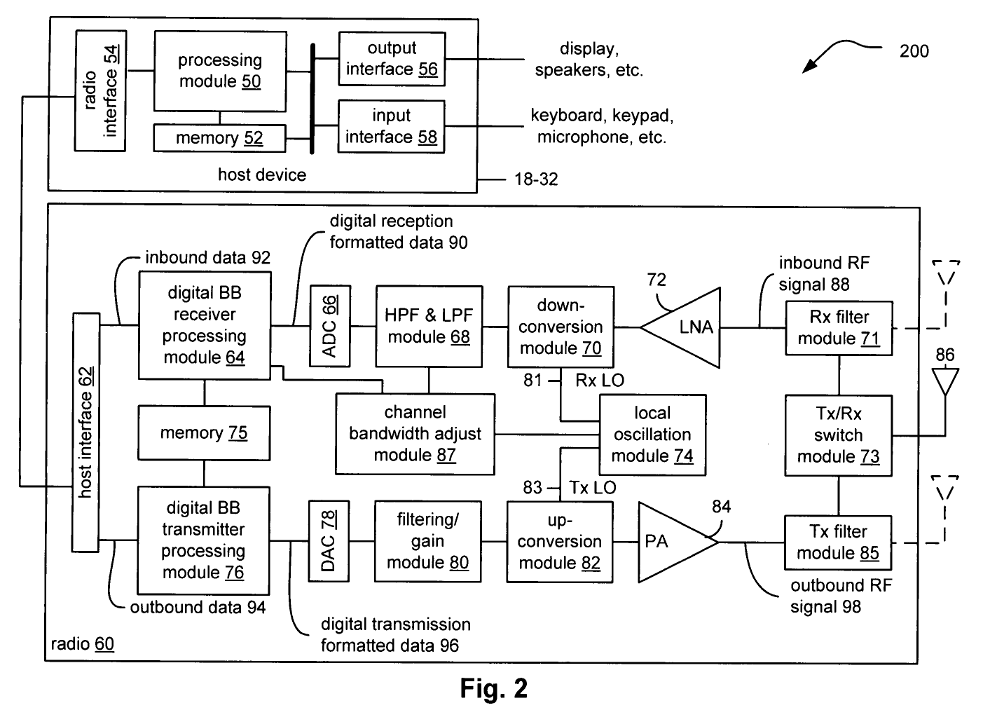

FIG. 1 is a diagram showing an embodiment of a communication system 100 that includes a plurality of base stations and/or access points 12, 16, a plurality of wireless communication devices 18-32 and a network hardware component 34. Note that the network hardware 34, which may be a router, switch, bridge, modem, system controller, etc. provides a wide area network connection 42 for the communication system 100. Further note that the wireless communication devices 18-32 may be laptop host computers 18 and 26, personal digital assistant hosts 20 and 30, personal computer hosts 24 and 32 and/or cellular telephone hosts 22 and 28. The details of the wireless communication devices will be described in greater detail with reference to FIG. 2.

Wireless communication devices 22, 23, and 24 are located within an independent basic service set (IBSS) area and communicate directly (i.e., point to point). In this configuration, these devices 22, 23, and 24 may only communicate with each other. To communicate with other wireless communication devices within the communication system 100 or to communicate outside of the communication system 100, the devices 22, 23, and/or 24 need to affiliate with one of the base stations or access points 12 or 16.

The base stations or access points 12, 16 are located within basic service set (BSS) areas 11 and 13, respectively, and are coupled to the network hardware 34 via local area network connections 36, 38. Such a connection provides the base station or access point 12 16 with connectivity to other devices within the communication system 100 and provides connectivity to other networks via the WAN connection 42. To communicate with the wireless communication devices within its BSS 11 or 13, each of the base stations or access points 12-16 has an associated antenna or antenna array. For instance, base station or access point 12 wirelessly communicates with wireless communication devices 18 and 20 while base station or access point 16 wirelessly communicates with wireless communication devices 26-32. Typically, the wireless communication devices register with a particular base station or access point 12, 16 to receive services from the communication system 100.

Typically, base stations are used for cellular telephone systems and like-type systems, while access points are used for in-home or in-building wireless networks (e.g., IEEE 802.11, IEEE 802.16, and versions thereof, Bluetooth®, and/or any other type of radio frequency based network protocol). Regardless of the particular type of communication system, each wireless communication device includes a built-in radio and/or is coupled to a radio.

FIG. 2 is a diagram showing an embodiment of a wireless communication device 200 that includes the host device 18-32 and an associated radio 60. For cellular telephone hosts, the radio 60 is a built-in component. For personal digital assistants hosts, laptop hosts, and/or personal computer hosts, the radio 60 may be built-in or an externally coupled component.

As illustrated, the host device 18-32 includes a processing module 50, memory 52, a radio interface 54, an input interface 58, and an output interface 56. The processing module 50 and memory 52 execute the corresponding instructions that are typically done by the host device. For example, for a cellular telephone host device, the processing module 50 performs the corresponding communication functions in accordance with a particular cellular telephone standard.

The radio interface 54 allows data to be received from and sent to the radio 60. For data received from the radio 60 (e.g., inbound data), the radio interface 54 provides the data to the processing module 50 for further processing and/or routing to the output interface 56. The output interface 56 provides connectivity to an output display device such as a display, monitor, speakers, etc. such that the received data may be displayed. The radio interface 54 also provides data from the processing module 50 to the radio 60. The processing module 50 may receive the outbound data from an input device such as a keyboard, keypad, microphone, etc. via the input interface 58 or generate the data itself. For data received via the input interface 58, the processing module 50 may perform a corresponding host function on the data and/or route it to the radio 60 via the radio interface 54.

Radio 60 includes a host interface 62, digital receiver processing module 64, an analog-to-digital converter 66, a high pass and low pass filter module 68, an IF mixing down conversion stage 70, a receiver filter 71, a low noise amplifier 72, a transmitter/receiver switch 73, a local oscillation module 74, memory 75, a digital transmitter processing module 76, a digital-to-analog converter 78, a filtering/gain module 80, an IF mixing up conversion stage 82, a power amplifier 84, a transmitter filter module 85, a channel bandwidth adjust module 87, and an antenna 86. The antenna 86 may be a single antenna that is shared by the transmit and receive paths as regulated by the Tx/Rx switch 73, or may include separate antennas for the transmit path and receive path. The antenna implementation will depend on the particular standard to which the wireless communication device 200 is compliant.

The digital receiver processing module 64 and the digital transmitter processing module 76, in combination with operational instructions stored in memory 75, execute digital receiver functions and digital transmitter functions, respectively. The digital receiver functions include, but are not limited to, digital intermediate frequency to baseband conversion, demodulation, constellation de-mapping, decoding, and/or descrambling. The digital transmitter functions include, but are not limited to, scrambling, encoding, constellation mapping, modulation, and/or digital baseband to IF conversion. The digital receiver and transmitter processing modules 64 and 76 may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 75 may be a single memory device or a plurality of memory devices. Such a memory device may be a read-only memory, random access memory, volatile memory, non-volatile memory, static memory, dynamic memory, flash memory, and/or any device that stores digital information. Note that when the processing module 64 and/or 76 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In operation, the radio 60 receives outbound data 94 from the host device via the host interface 62. The host interface 62 routes the outbound data 94 to the digital transmitter processing module 76, which processes the outbound data 94 in accordance with a particular wireless communication standard (e.g., IEEE 802.11, IEEE 802.16, Bluetooth®, etc.) to produce outbound baseband signals 96. The outbound baseband signals 96 will be digital base-band signals (e.g., have a zero IF) or digital low IF signals, where the low IF typically will be in the frequency range of one hundred kHz (kilo-Hertz) to a few MHz (Mega-Hertz).

The digital-to-analog converter 78 converts the outbound baseband signals 96 from the digital domain to the analog domain. The filtering/gain module 80 filters and/or adjusts the gain of the analog signals prior to providing it to the IF mixing stage 82. The IF mixing stage 82 converts the analog baseband or low IF signals into RF signals based on a transmitter local oscillation 83 provided by local oscillation module 74. The power amplifier 84 amplifies the RF signals to produce outbound RF signals 98, which are filtered by the transmitter filter module 85. The antenna 86 transmits the outbound RF signals 98 to a targeted device such as a base station, an access point and/or another wireless communication device 200.

The radio 60 also receives inbound RF signals 88 via the antenna 86, which were transmitted by a base station, an access point, or another-wireless communication device. The antenna 86 provides the inbound RF signals 88 to the receiver filter module 71 via the Tx/Rx switch 73, where the Rx filter 71 bandpass filters the inbound RF signals 88. The Rx filter 71 provides the filtered RF signals to low noise amplifier 72, which amplifies the signals 88 to produce an amplified inbound RF signals. The low noise amplifier 72 provides the amplified inbound RF signals to the IF mixing module 70, which directly converts the amplified inbound RF signals into an inbound low IF signals or baseband signals based on a receiver local oscillation 81 provided by local oscillation module 74. The down conversion module 70 provides the inbound low IF signals or baseband signals to the filtering/gain module 68. The high pass and low pass filter module 68 filters, based on settings provided by the channel bandwidth adjust module 87, the inbound low IF signals or the inbound baseband signals to produce filtered inbound signals.

The analog-to-digital converter 66 converts the filtered inbound signals from the analog domain to the digital domain to produce inbound baseband signals 90, where the inbound baseband signals 90 will be digital base-band signals or digital low IF signals, where the low IF typically will be in the frequency range of one hundred kHz to a few MHz. The digital receiver processing module 64, based on settings provided by the channel bandwidth adjust module 87, decodes, descrambles, de-maps, and/or demodulates the inbound baseband signals 90 to recapture inbound data 92 in accordance with the particular wireless communication standard being implemented by radio 60. The host interface 62 provides the recaptured inbound data 92 to the host device 18-32 via the radio interface 54.

As one of average skill in the art will appreciate, the wireless communication device 200 of FIG. 2 may be implemented using one or more integrated circuits. For example, the host device may be implemented on one integrated circuit, the digital receiver processing module 64, the digital transmitter processing module 76 and memory 75 may be implemented on a second integrated circuit, and the remaining components of the radio 60, less the antenna 86, may be implemented on a third integrated circuit. As an alternate example, the radio 60 may be implemented on a single integrated circuit. As yet another example, the processing module 50 of the host device and the digital receiver and transmitter processing modules 64 and 76 may be a common processing device implemented on a single integrated circuit. Further, the memory 52 and memory 75 may be implemented on a single integrated circuit and/or on the same integrated circuit as the common processing modules of processing module 50 and the digital receiver and transmitter processing module 64 and 76.

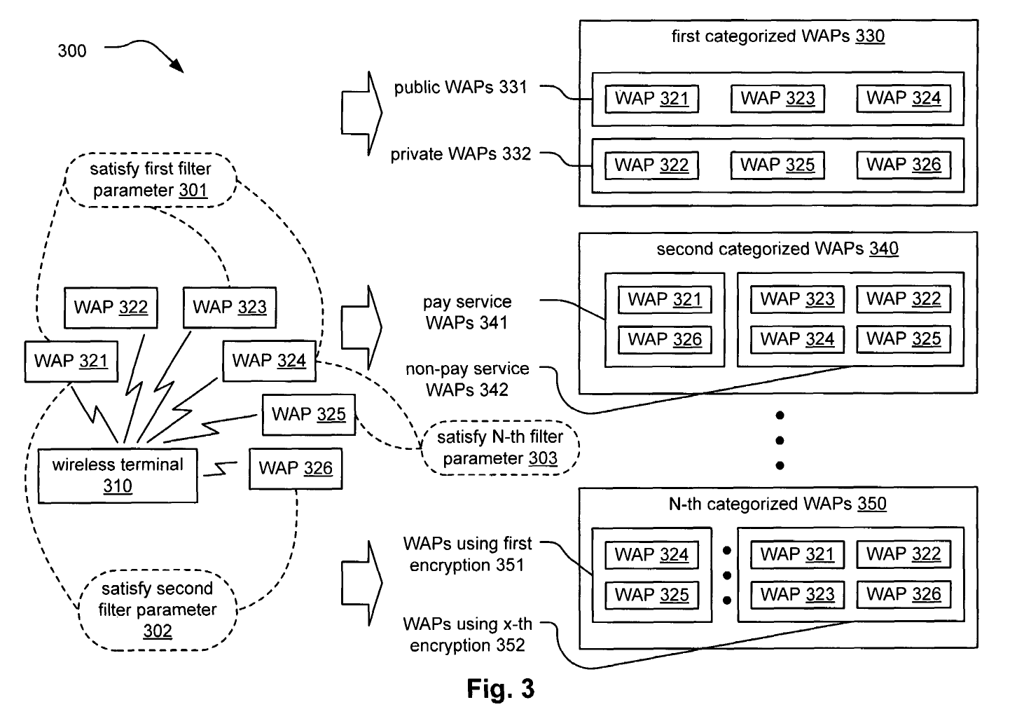

FIG. 3 is a diagram showing an embodiment of categorization 300 of a plurality of WAPs (i.e., WAPs 321, 322, 323, 324, 325, and 326) according to a variety of filter parameters. A number of filter parameters can be employed to perform the categorization 300. For example, a wireless terminal 310 is operable to detect each of the WAPs 321, 322, 323, 324, 325, and 326, and the wireless terminal 310 then determines with which WAP to connect. This can involve user intervention, or it can be performed automatically according to certain filter parameters employed by the wireless terminal 310.

Any of these WAPs 321, 322, 323, 324, 325, and 326 can be one of a variety of WAPs, including a WAP that is operable to support communication via more than one standard, and/or protocol. For example, any one WAP can be a wireless local area network access point that is compatible with the IEEE 802.11 standard. Alternatively, any one WAP can be a WiMAX access point that is compatible with the IEEE 802.16 standard. In even other embodiments, any one of the WAPs can be a cellular WAP. The wireless terminal 310 can be implemented to connect to any of the WAPs 321, 322, 323, 324, 325, and 326.

A first filter parameter 301 can divide the WAPs 321, 322, 323, 324, 325, and 326 into those that are public, and those which are private, as indicated by the first categorized WAPs 330. Specifically in this embodiment, the WAPs 321, 323, and 324 are public WAPs 331, and the WAPs 322, 325, and 326 are private WAPs 332.

A second filter parameter 302 can divide the WAPs 321, 322, 323, 324, 325, and 326 into those that are pay service WAPs, and those which are non-pay service WAPs, as indicated by the second categorized WAPs 340. Specifically in this embodiment, the WAPs 321 and 326 are pay service WAPs 341, and the WAPs 322, 323, 324, and 325 are non-pay service WAPs 342.

Generally, any number of filter parameters can be employed. An N-th filter parameter 303 is shown which can divide the WAPs 321, 322, 323, 324, 325, and 326 into those that are employ any of a variety of different encryption types. For example, in this embodiment, the WAPs 324 and 325 are shown as being WAPs which use a first encryption type, as shown by reference numeral 351. The WAPs 321, 322, 323, and 326 are shown as being WAPs which use an x-th encryption type, as shown by reference numeral 352.

According to certain filter parameters, there is a simple bifurcation as characterizing a particular WAP within one of only two possible types of WAPs (e.g., pay vs. non-pay). According to other filter parameters, there is a more detailed categorization of a particular WAP as being included within one of a plurality of possible types of WAPs (e.g., using first encryption type, second encryption type, and so on).

If desired, certain combinations of filter parameters can be employed. For example, another filter parameter can be defined as including the constraints of both the first filter parameter and the second filter parameter. Generally, any additional filter parameter can be employed which is a combination of some of the original filter parameters as well.

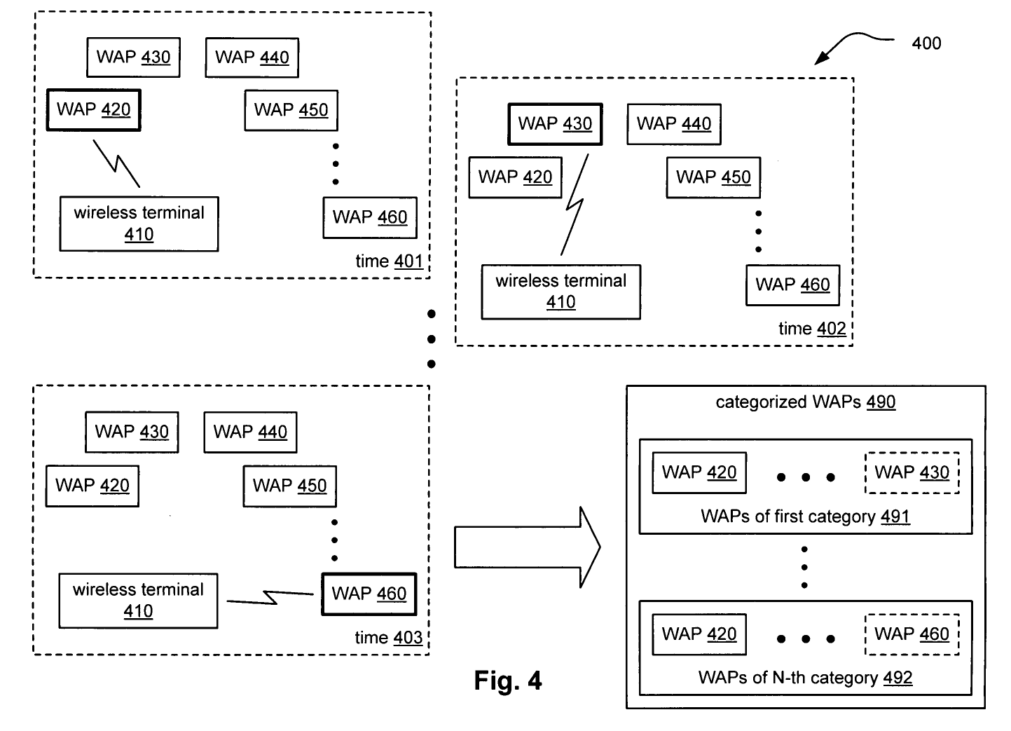

FIG. 4 is a diagram showing an embodiment of sequential categorization 400 of a plurality of WAPs according to a variety of filter parameters. A wireless terminal 410 is operable to establish a certain degree of connectivity with each WAP within the plurality of WAPs 420-460. This connectivity with each WAP can be viewed as being sufficient to characterize the given WAP but not as full establishing communication therewith. For example, the wireless terminal 410 is implemented to detect each of the WAPs 420-460. Looking at one example, for certain pay-service WAPs, a communication is provided from the pay-service WAP back to the wireless terminal 410 provide a login type web page (e.g., to subscribe to the pay service for network access). For even some non-pay service WAPs, there is nevertheless some authorization required for connectivity. However, as a very minimum, this preliminary communication with each WAP for the purposes of characterization can be viewed as at least being detection of that WAP for the purposes of applying one or more filtering. For certain other filter parameters, perhaps a slightly upgraded form of communication may be needed (e.g., such as characterizing the WAP as being a pay-service WAP which could include the WAP transmitting subscription information back to the wireless terminal 410).

During a time 401, the wireless terminal 410 establishes sufficient communication with the WAP 420 to apply the one or more filter parameters thereto. Then, during a time 402, the wireless terminal 410 establishes sufficient communication with the WAP 430 to apply the one or more filter parameters thereto. The wireless terminal 410 continues this process so that the one or more filter parameters can be applied to each of the WAPs successively. Then, during a time 403, the wireless terminal 410 establishes sufficient communication with the WAP 460 to apply the one or more filter parameters thereto.

As can be seen each of the WAPs is categorized (see reference numeral 490) according to one or more filter parameters. Again, any combination of the one or more filter parameters can be combined to generate at least one additional filter parameter as well.

Looking at this example, WAP 420-430 are included within WAPs of a first category 491. WAP 420-460 are included within WAPs of an N-th category 492. The number of categories can be varied as desired in various applications.

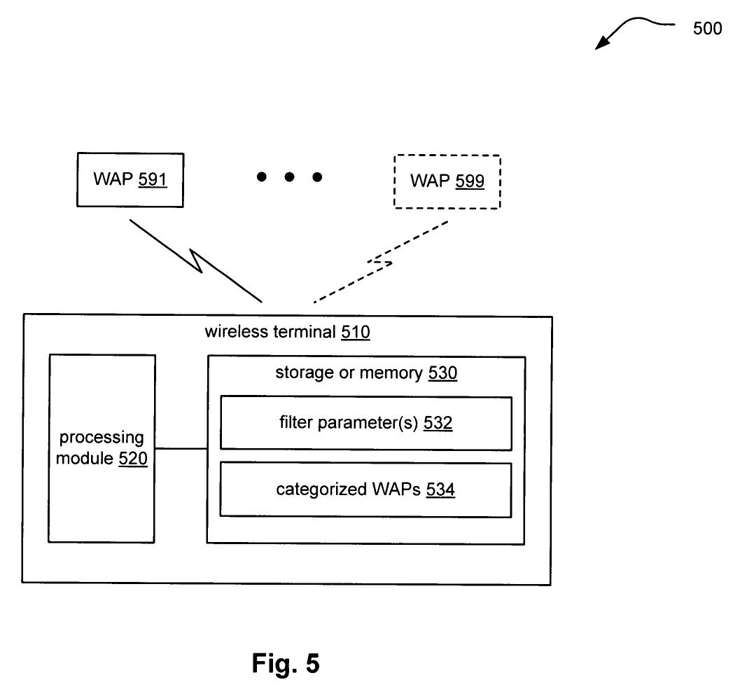

FIG. 5 is a diagram showing an embodiment of communication system 500 including a wireless terminal 510 and one or more WAPs 591-599. The wireless terminal 510 includes a processing module 520 that is coupled to a storage or memory 530 that is operable to store certain information, including that which may be employed to enable to the processing module 520 to perform certain functions.

The processing module 520 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The storage or memory 530 may be a single memory device or a plurality of memory devices. Such a memory device may be a read-only memory, random access memory, volatile memory, non-volatile memory, static memory, dynamic memory, flash memory, and/or any device that stores digital information. Note that when the processing module 520 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. The storage or memory 530 stores, and the processing module 520 executes, operational instructions corresponding to at least some of the steps and/or functions herein.

The wireless terminal 510 is operable to establish sufficient communication with each of the one or more WAPs 591-599 (i.e., communication sufficient at least to characterize each particular WAP, which may be as limited as merely detection in some embodiments). The storage or memory 530 is operable to store one or more filter parameters that is employed to perform the characterization and categorization of each of the WAPs such as indicated by reference numeral 534.

The wireless terminal 510 can be implemented to communicate simultaneously with each of the one or more WAPs 591-599 (e.g., in parallel), in succession (e.g., in a serial type configuration, one after another), or otherwise as desired in a particular embodiment.

Moreover, the one or more filter parameters 532 can be modified over time. For example, they can be modified as programmed according to a particular sequence, they can be modified based on which particular WAPs are in fact detected by the wireless terminal 510, or they can be modified as directed by a user of the wireless terminal 510 through some type of user interface.

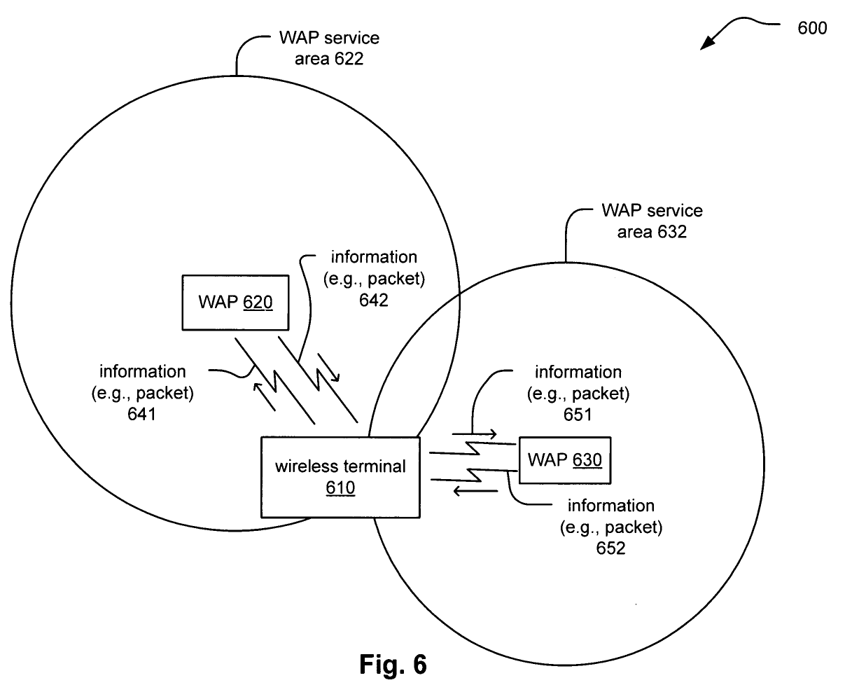

FIG. 6 is a diagram showing an embodiment of a communication system 600 that includes a wireless terminal 610 and a plurality of WAPs that are operable to support bi-directional communication there between that can be employed for determining operational and performance measures that can be used for categorizing the WAPs using one or more filter parameters. In one embodiment, a certain degree of bi-directional communication can be performed during association between the wireless terminal 610 and each WAP of the plurality of WAPs.

In this embodiment, first information (e.g., a first packet) is transmitted in one direction along each communication link between the wireless terminal 610 and each WAP during a first time. Then, second information (e.g., a second packet) is transmitted in the opposite direction along each communication link between the wireless terminal 610 and each WAP during a second time. The first information may be transmitted from the wireless terminal 610 to a WAP during the first time, and the second packet may be transmitted from that WAP to the wireless terminal 610 to a WAP during the second time. The converse may alternatively be employed. For example, the first information may be transmitted from a WAP to the wireless terminal 610 during the first time, and the second information may be transmitted from the wireless terminal 610 to that WAP during the second time.

Looking specifically at the diagram, first information 641 is transmitted in one direction along a communication link between the wireless terminal 610 and the WAP 620 during a first time, and a second packet 642 is transmitted in the opposite direction along the communication link between the WAP 620 and the wireless terminal 610 during a second time. Analogously, first information 651 is transmitted in one direction along a communication link between the wireless terminal 610 and the WAP 630 during a first time, and second information 652 is transmitted in the opposite direction along the communication link between the WAP 630 and the wireless terminal 610 during a second time.

Regardless of which information or packet transmission is first and which is second, a round trip communication between the wireless terminal 610 and each of the respective WAPs allows for an accurate determination of one or more operational and performance measures as well as for categorizing the WAPs using one or more filter parameters for each corresponding communication link. This characterization can then be employed in the decision making processes regarding with which WAP the wireless terminal 610 should connect.

Using this bi-directional communication link characterization, then a device at one end of the communication link has knowledge of what is sent, and the device at the other end of the communication link will knowledge of what is received. Therefore, an accurate assessment of the various parameters of the communication link can be made. By using a bi-directional approach, then full information can be made available (i.e., what is sent and received in one direction, and what is sent and received in the other direction). Also, by using a bi-directional approach, then devices at both ends of the communication link can participate in the communication link characterization; for example, one device can perform a first portion of the characterization, and the other device can perform a second portion of the characterization.

In even another embodiment, a singular information or packet is only transmitted in one direction (e.g., from wireless terminal 610 to a WAP, or from that WAP to the wireless terminal 610), and the corresponding receiving device is operable to determine one or more operational and performance measures that can be employed for categorizing the WAPs using one or more filter parameters. While this uni-directional approach may be slightly less accurate, in some cases, than a system employing a bi-directional approach, it nevertheless shows how the characterization of the respective communication links, and their corresponding WAPs, within the communication system 600 can be achieved.

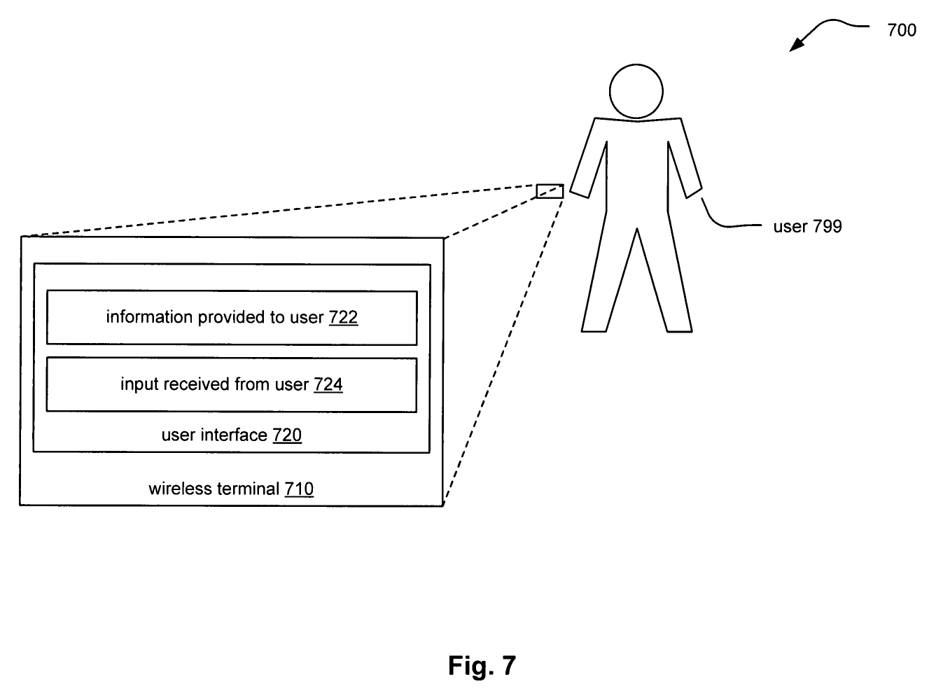

FIG. 7 is a diagram showing an embodiment of interfacing 700 between a user 799 and a wireless terminal 710. The wireless terminal 710 includes a user interface 720 that is operable to provide information to the user 799 (as shown by reference numeral 722) and is operable to receive input from the user 799 (as shown by reference numeral 724).

Through this user interface 720, the user 799 has the opportunity to program and select certain of the decision making means (e.g., which one or more filter parameters to employ) that are employed to make connection decisions with respect to any particular WAP. This can include which filter parameters are employed to characterize any WAP as being an available WAP or an unavailable WAP, or even as a private WAP or a public WAP.

In addition, the user interface 720 can be employed to display certain information to the user 799, such as which WAPs are detected, which WAPs are available, which WAPs are deemed as being available, which WAPs are deemed as being unavailable, and so on. Even the information provided to the user 799 via the user interface 720 can be programmed or selected by the user 799. For example, the user 799 can select, via reference numeral 724, that only available WAPs are displayed to the user 799. For example, even if the wireless terminal 710 detects a particular WAP, if that WAP does not meet the particular decision making criteria (e.g., such as the wireless terminal's mobility with respect to a WAP), then that particular WAP is not included within the plurality of available WAPs.

Any of a wide variety of types of a wireless terminal 710 that is operable to connect to one or more types of WAPs can be employed in this embodiment, including PDAs, personal computers (including lap-top computers), other portable computer types, cell phones, and so on. Any wireless terminal 710 that is operable to connect to one or more types of WAPs can include this interfacing 700 to a user 799. From this interfacing 700, the user can then select any one or more of the constraints (e.g., thresholds) employed to make decisions regarding connecting to a particular WAP, and the user 799 can be provided with any desired information such as whether a particular WAP is available or unavailable (according to the categorization being employed for the communication device 710). In addition, this information provided to the user 799 can be provided in a format that has been selected by the user 799.

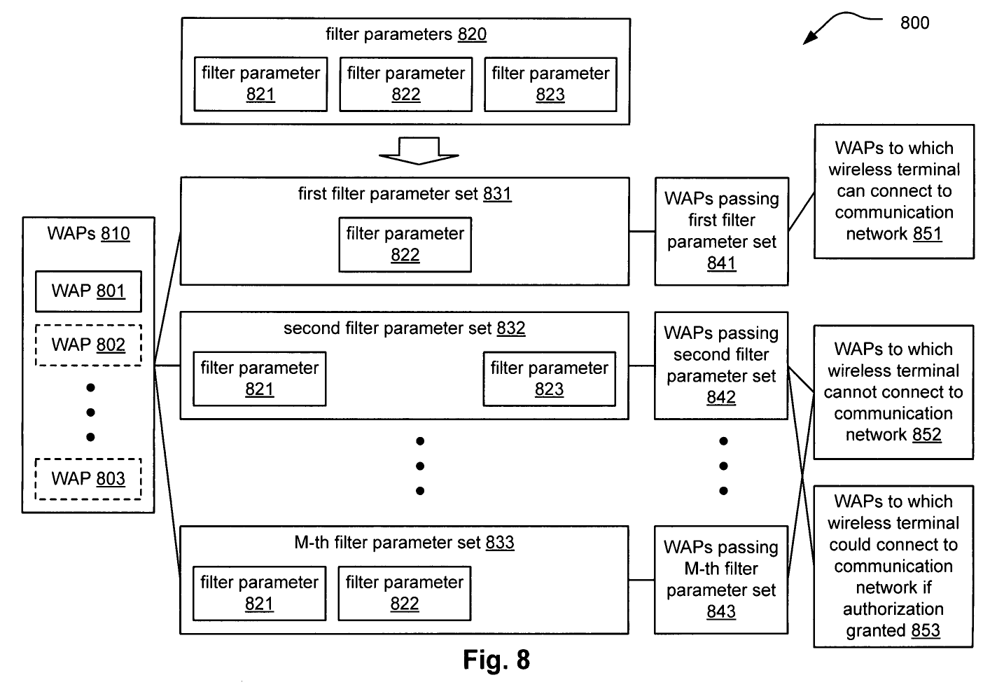

FIG. 8 is a diagram showing an embodiment of one or more WAPs 810 (that includes WAP 801, and may also include WAP 802-803) that undergoes categorization according to number of different filter parameter sets (i.e., filter parameter sets 831, 832-833). A number of available filter parameters 820, that includes at least filter parameter 821, filter parameter 823, and filter parameter 823, are appropriately arranged and combined to form a number of filter parameter sets shown as a first filter parameter set 831 (that includes filter parameter 822), a second filter parameter set 832 (that includes filter parameter 821 and filter parameter 823), and an M-th filter parameter set 833 (that includes filter parameter 821 and filter parameter 822).

Each of the WAPs 810 are processed according to each of the filter parameter sets 831-833, so that it is determined which of the WAPs 810 pass or meet with the constraints required by each of the filter-parameter sets. In some cases, there are no WAPs which pass or meet with the constraints imposed by a particular filter parameter set.

Looking specifically at the diagram, those WAPs that have passed the first filter parameter set are indicated by reference numeral 841. Those WAPs that have passed the second filter parameter set are indicated by reference numeral 842, and those WAPs that have passed the M-th filter parameter set are indicated by reference numeral 843.

Furthermore, based on which of these WAPs have passed these various filter parameter sets, additional categorization can also be performed such as indicating which of these groups (that have passed a particular filter parameter set) includes WAPs to which a wireless terminal can connect thereby gaining a pathway to the communication network of interest (e.g., the Internet in one embodiment), as indicated by reference numeral 851. For example, in one embodiment, the WAPs that have passed the first filter parameter set 841 may include a WAP that operates according to a particular standard, and yet a user's wireless terminal may not have the ability to connect to that WAP for some reason (e.g., pathway to the wireless terminal is not compatible with that particular standard.

Another perspective of this embodiment shows how the decision making process of categorizing WAPs may be accessed at different points along the categorizing processing. For example, even after a WAP has passed a first filter parameter set (i.e., 831), further categorizing of that particular WAP can also be performed.

Another categorization can also be performed that indicates which of these groups (that have passed a particular filter parameter set) includes WAPs to which a wireless terminal cannot connect and cannot thereby gain a pathway to the communication network of interest (e.g., pathway to the Internet in one embodiment), as indicated by reference numeral 852. Even another categorization could include WAPs to which a wireless terminal could connect if authorization were granted and thereby gain a pathway to the communication network of interest (e.g., pathway to the Internet in one embodiment), as indicated by reference numeral 853.

In some embodiments, the final categorization of the WAPs could also be to one of two possible groups: available WAPs and unavailable WAPs. It is also noted, as with other embodiments described herein, that the categorizing and application of one or more filter parameters can be performed again at a later time to update or refine the previously performed categorization. This subsequent application of the one or more filter parameters can be initiated after a particular amount of time has passed, by user intervention, or according to some other means.

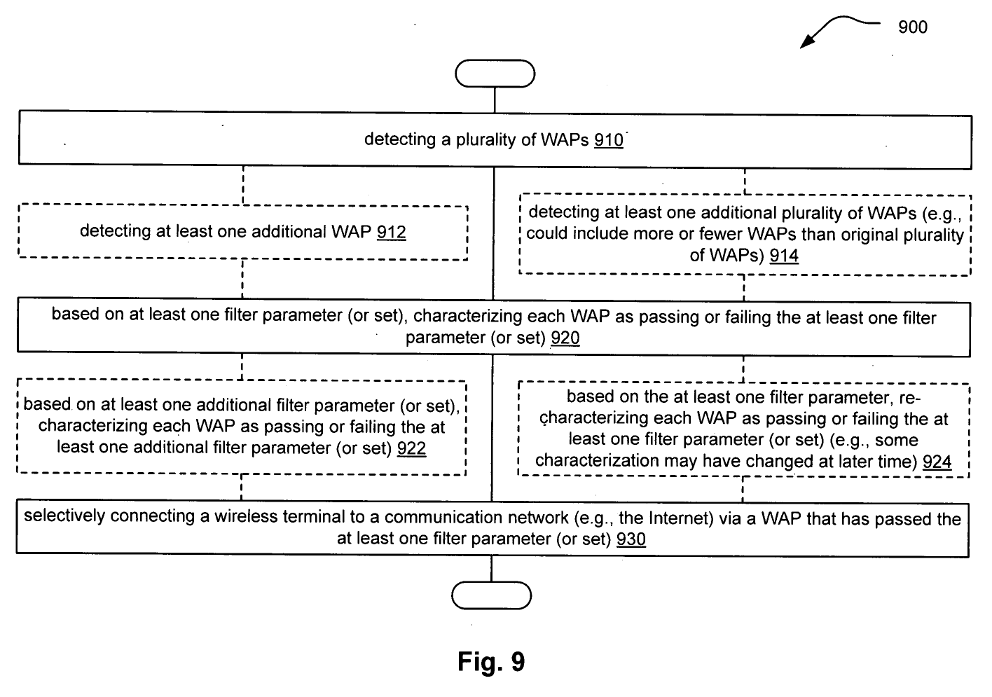

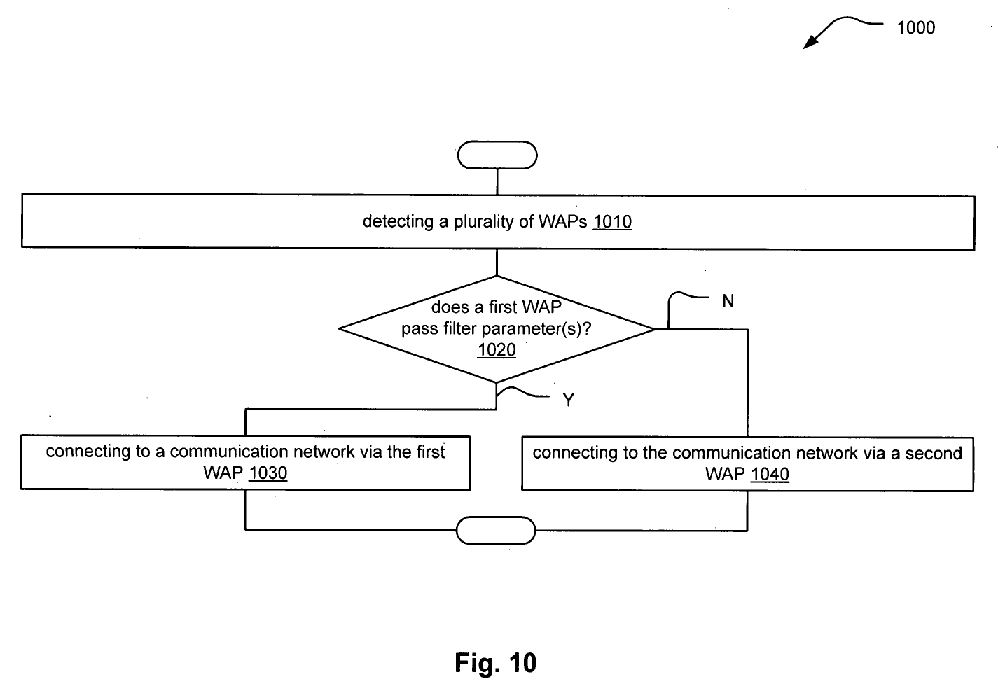

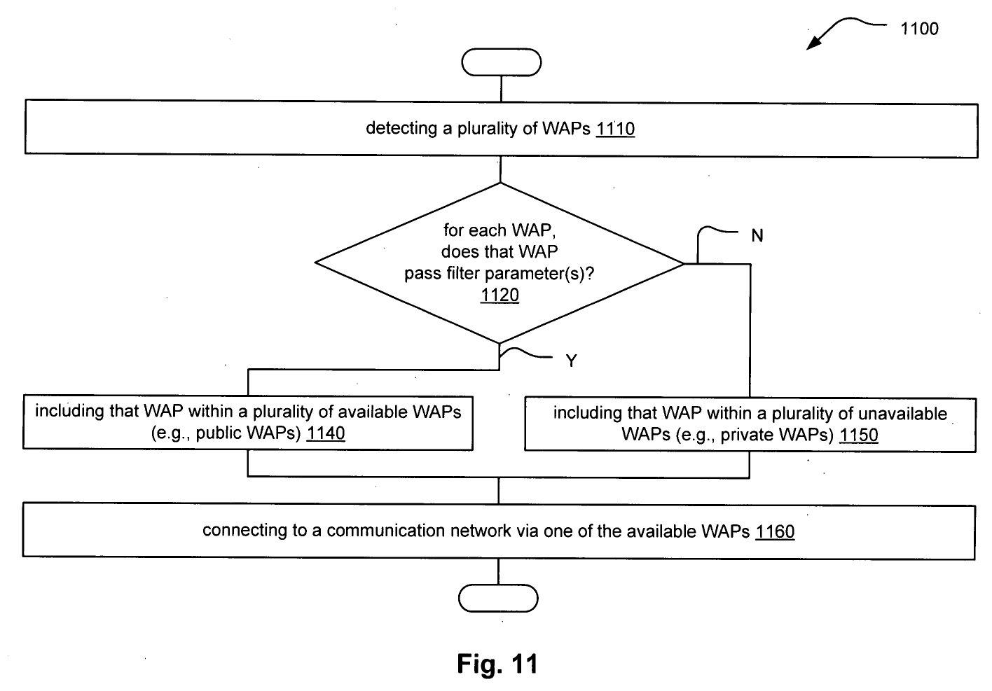

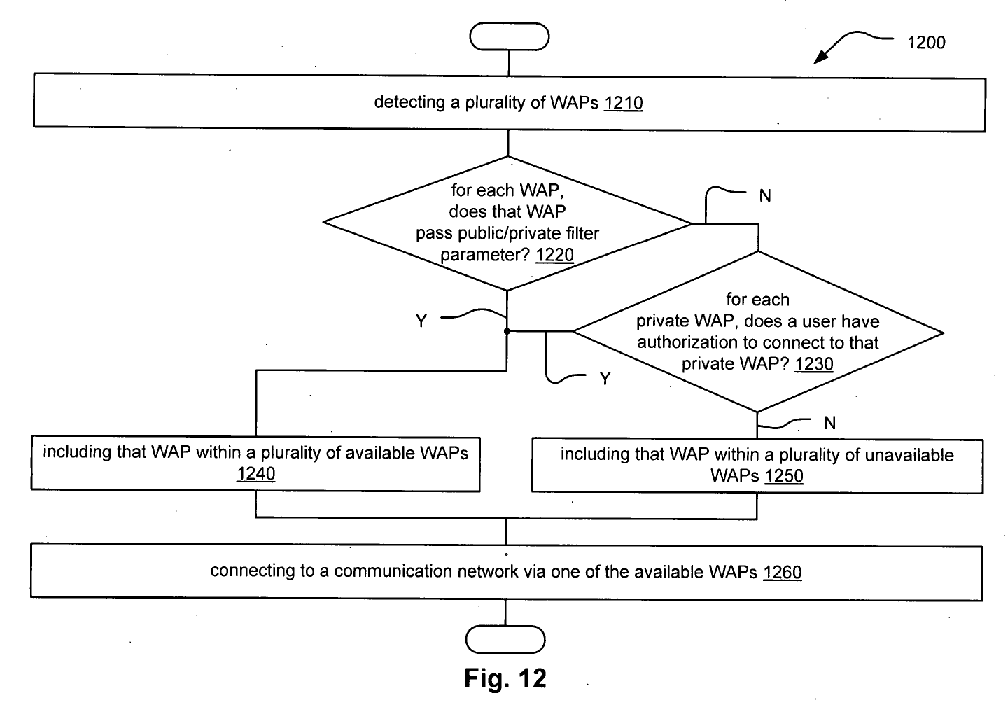

FIG. 9, FIG. 10, FIG. 11, and FIG. 12 are diagrams showing embodiments of methods for selectively connecting a wireless terminal to a communication network (e.g., to the Internet) via a WAP.

Referring to the method 900 of FIG. 9, the method 900 begins by detecting a plurality of WAPs as shown in a block 910. In some embodiments, the method 900 then also performs detecting of at least one additional WAP, as'shown in a block 912, or detecting of at least one additional plurality of WAPs, as shown in a block 914.

The at least one additional WAP, as shown in a block 912, indicates that WAPs, as they become available and detected, can be processed as well as the originally detected plurality of WAPs in the block 910. The at least one additional plurality of WAPs, as shown in a block 914, can possibly include more or fewer WAPs, or some of the same WAPs, as the original plurality of WAPs that is detected as shown in a block 910.

Thereafter, based on at least one filter parameter, the method 900 involves characterizing each WAP as passing or failing the at least one filter parameter (or filter parameter set), as shown in a block 920. In some embodiments, the method 900 then also performs characterizing each WAP as passing or failing at least one additional filter parameter (or filter parameter set), as shown in a block 922. If also desired, the method 900 involves re-characterizing each WAP as passing or failing the at least one filter parameter (or filter parameter set), as shown in a block 924. For example, additional information may have become available after performing the initial characterization of each WAP in the block 920, and a re-characterization (in the block 924) may provide a better or more accurate characterization of a particular WAP.

Then, after the appropriate application of the at least one filter parameter (or filter parameter set) has been performed, the method 900 involves selectively connecting a wireless terminal to a communication network via a WAP that has passed the at least one filter parameter (or filter parameter set), as shown in a block 930.

Referring to the method 1000 of FIG. 10, the method 1000 begins by detecting a plurality of WAPs, as shown in a block 1010. As shown in a decision block 1020, the method 1000 continues by determining whether a first WAP passes one or more filter parameters. Then, if the first WAP does pass the one or more filter parameters within the block 1020 (i.e., a yes is determined therein), the method 1000 continues by connecting to a communication network via the first WAP, as shown in a block 1030. Alternatively, if the first WAP does not pass the one or more filter parameters within the block 1020 (i.e., a no is determined therein), the method 1000 continues by connecting to a communication network via a second WAP, as shown in a block 1040.

Referring to the method 1100 of FIG. 11, the method 1100 begins by detecting a plurality of WAPs, as shown in a block 1110. The method 1100 then continues by determining whether each of the particular detected WAPs passes one or more filter parameters, as shown in a decision block 1120. For each WAP, if that particular WAP does pass the one or more filter parameters within the block 1120 (i.e., a yes is determined therein), the method 1100 continues by including that particular WAP within a plurality of available WAPs, as shown in a block 1140. Alternatively, for each WAP, if that particular WAP does not pass the one or more filter parameters within the block 1120 (i.e., a no is determined therein), the method 1100 continues by including that particular WAP within a plurality of unavailable WAPs, as shown in a block 1150.

The partitioning of the WAPs into the plurality of available WAPs and the plurality of unavailable WAPs may be along the lines of public WAPs and private WAPs. Alternatively, the partitioning of the WAPs into the plurality of available WAPs and the plurality of unavailable WAPs may be along the lines of private WAPs to which a user has authorization to connect and private WAPs to which the user has no authorization to connect. There are a variety of means by which the WAPs can be divided as indicating those to which connecting is available (i.e., available WAPs) and those to which connecting is not available (i.e., unavailable WAPs).

After this categorizing of the WAPs into the available and unavailable WAPs has been performed, the method 1100 continues by connecting to a communication network via one of the available WAPs, as shown in a block 1160.

Referring to the method 1200 of FIG. 12, the method 1200 begins by detecting a plurality of WAPs, as shown in a block 1210. The method 1200 then continues by determining whether each of the particular detected WAPs passes office action public/private filter parameter, as shown in a decision block 1220. For each WAP, if that particular WAP does pass the one or more filter parameters within the block 1220 (i.e., a yes is determined therein), the method 1200 continues by including that particular WAP within a plurality of available WAPs, as shown in a block 1240. Alternatively, for each WAP, if that particular WAP does not pass the one or more filter parameters within the block 1220 (i.e., a no is determined therein), the method 1200 continues by further determining whether, for each those detected private WAPs, a user has authorization to connect to that particular WAP, as shown in a decision block 1230.

For each of the private WAPs, if the user does have authorization to connect to that particular private WAP as determined within the block 1230 (i.e., a yes is determined therein), the method 1200 continues by including that particular private WAP within the plurality of available WAPs, as shown in the block 1240. Alternatively, for each of the private WAPs, if the user does not have authorization to connect to that particular private WAP as determined within the block 1230 (i.e., a no is determined therein), the method 1200 continues by including that particular private WAP within a plurality of unavailable WAPs, as shown in the block 1250.

After this categorizing of the WAPs into the available and unavailable WAPs has been performed, the method 1200 continues by connecting to a communication network via one of the available WAPs, as shown in a block 1260.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A wireless terminal in a packet switched communication network, the packet switched communication network including a plurality of wireless access points (WAPs), each WAP of the plurality of WAPs has a corresponding Internet pathway characteristic, the wireless terminal comprising:
a radio circuitry that receives a plurality of packets, such that each packet of the plurality of WAPs corresponds to one WAP of the plurality of WAPs;
storage that contains at least one filter parameter;
a processing circuitry that processes the plurality of the packets to determine a plurality of Internet pathway characteristics, such that each Internet pathway characteristic corresponds to one WAP of the plurality of WAPs; and wherein:
based on at least one filter parameter as applied to the plurality of Internet pathway characteristics, the processing circuitry selects a WAP from the plurality of WAPs; and
the radio connects to the selected WAP thereby providing Internet connectivity to the wireless terminal.

2. The wireless terminal of claim 1, wherein:
the storage contains a plurality of filter parameters;
the at least one filter parameter is one filter parameter of the plurality of filter parameters; and
based on at least two filter parameters of the plurality of filter parameters, the processing circuitry selects a WAP from the plurality of WAPs.

3. The wireless terminal of claim 1, wherein:
the processing circuitry stores the plurality of Internet pathway characteristics in the storage.

4. The wireless terminal of claim 1, wherein:
at least one Internet pathway characteristic of the plurality of Internet pathway characteristics is an encryption characteristic, a security characteristic, a payment requirement, or a private WAP indication.

5. The wireless terminal of claim 1, wherein:
the radio associates with each WAP of the plurality of WAPs before receiving the plurality of packets from each WAP of the plurality of WAPs.

6. The wireless terminal of claim 1, wherein:
one packet of the plurality of packets received from by the wireless terminal from one WAP of the plurality of WAPs indicates that corresponding WAP's Internet pathway characteristic.

7. The wireless terminal of claim 1, wherein:
the radio associates with a WAP of the plurality of WAPs;
the wireless terminal pings a predetermined Internet site via the WAP with which the radio associates; and
if the wireless terminal receives an echoed packet from the predetermined Internet site in response to the ping, then the processing circuitry employs the echoed packet to determine the Internet pathway characteristic corresponding to that WAP of the plurality of WAPs.

8. The wireless terminal of claim 1, wherein:
the selected WAP is a first WAP;
when communication between the wireless terminal and the first WAP becomes unacceptable, then the processing circuitry selects a second WAP from the plurality of WAPs; and
the radio switches its connection from the first WAP to the second WAP.

9. The wireless terminal of claim 1, further comprising:
a user interface; and wherein:
the selection of the selected WAP by the processing circuitry is also based on user input provided to the processing circuitry via the user interface.

10. The wireless terminal of claim 1, further comprising:
a user interface; and wherein:
the processing circuitry presents via the user interface only a WAP of the plurality of WAPs that has a sufficient Internet pathway characteristic as defined, at least in part, by the at least one filter parameter.

11. The wireless terminal of claim 1, further comprising:
a user interface; and wherein:
the processing circuitry presents via the user interface each WAP of the plurality of WAPs and indicates, for each WAP, whether or not that particular WAP has a sufficient Internet pathway characteristic as defined, at least in part, by the at least one filter parameter.

12. The wireless terminal of claim 1, wherein:
one WAP within the plurality of WAPs is a wireless local area network access point that is compatible with the IEEE 802.11 standard or a WiMAX access point that is compatible with the IEEE 802.16 standard.

13. A wireless terminal in a packet switched communication network, the packet switched communication network including a plurality of wireless access points (WAPs), each WAP of the plurality of WAPs has a corresponding Internet pathway characteristic, the wireless terminal comprising:
a user interface;
a radio circuitry that receives a plurality of packets, such that each packet of the plurality of WAPs corresponds to one WAP of the plurality of WAPs;
storage that contains at least one filter parameter;
a processing circuitry that processes the plurality of the packets to determine a plurality of Internet pathway characteristics, such that each Internet pathway characteristic corresponds to one WAP of the plurality of WAPs; and wherein:
based on at least one filter parameter as applied to the plurality of Internet pathway characteristics and user input provided to the processing circuitry via the user interface, the processing circuitry selects a first WAP from the plurality of WAPs;
the radio connects to the first WAP thereby providing Internet connectivity to the wireless terminal;
when communication between the wireless terminal and the first WAP becomes unacceptable, then the processing circuitry selects a second WAP from the plurality of WAPs; and
the radio switches its connection from the first WAP to the second WAP.

14. The wireless terminal of claim 13, wherein:
at least one Internet pathway characteristic of the plurality of Internet pathway characteristics is an encryption characteristic, a security characteristic, a payment requirement, or a private WAP indication.

15. The wireless terminal of claim 13, wherein:
the radio associates with each WAP of the plurality of WAPs before receiving the plurality of packets from each WAP of the plurality of WAPs.

16. The wireless terminal of claim 13, wherein:
one packet of the plurality of packets received from by the wireless terminal from one WAP of the plurality of WAPs indicates that corresponding WAP's Internet pathway characteristic.

17. The wireless terminal of claim 13, wherein:
the radio associates with a WAP of the plurality of WAPs;
the wireless terminal pings a predetermined Internet site via the WAP with which the radio associates; and
if the wireless terminal receives an echoed packet from the predetermined Internet site in response to the ping, then the processing circuitry employs the echoed packet to determine the Internet pathway characteristic corresponding to that WAP of the plurality of WAPs.

18. A method performed by a wireless terminal in a packet switched communication network, the packet switched communication network including a plurality of wireless access points (WAPs), each WAP of the plurality of WAPs has a corresponding Internet pathway characteristic, the method comprising:
receiving a plurality of packets, such that each packet of the plurality of WAPs corresponds to one WAP of the plurality of WAPs;
processing the plurality of the packets to determine a plurality of Internet pathway characteristics, such that each Internet pathway characteristic corresponds to one WAP of the plurality of WAPs;
based on at least one filter parameter as applied to the plurality of Internet pathway characteristics, selecting a WAP from the plurality of WAPs; and
connecting to the selected WAP thereby providing Internet connectivity to the wireless terminal.

19. The method of claim 18, wherein:
one packet of the plurality of packets that is received from one WAP of the plurality of WAPs indicates that corresponding WAP's Internet pathway characteristic.

20. The method of claim 18, further comprising:
presenting via a user interface only a WAP of the plurality of WAPs that has a sufficient Internet pathway characteristic as defined, at least in part, by the at least one filter parameter; or
presenting via the user interface each WAP of the plurality of WAPs and indicating, for each WAP, whether or not that particular WAP has a sufficient Internet pathway characteristic as defined, at least in part, by the at least one filter parameter.
